(19) United States
(12) Patent Application Publication
(10) Pub. No.: US 2002/0060174 A1
(43) Pub. Date: May 23, 2002

(54) Sorting device and quality inspection apparatus using the same

(75) Inventor: Masayoshi Nakajima, Shiga (JP)

Correspondence Address: STAAS & HALSEY LLP, 700 11TH STREET, NW, SUITE 500, WASHINGTON, DC, 20001, US

(73) Assignee: ISHIDA CO., LTD., Kyoto (JP)

(21) Appl. No.: 09/984,737

(22) Filed: Oct. 31, 2001

(30) Foreign Application Priority Data
Nov. 20, 2000 (JP) 352316/2000

(51) Int. Cl. B07C 5/00

(52) U.S. Cl. 209/644; 209/645; 209/932

(57) ABSTRACT

A sorting device in which a nozzle (31) having a flat tip portion (31a) for blowing air to a predetermined article X transported by a pair of transport belts (23, 23) is covered with a nozzle cover (32) whose forward-oriented and rearward-oriented end portions in the direction of air blowing are open and whose forward opening (32a) is located forward of the tip portion (31a) of the nozzle (31). Then, by covering above the transport belts (23, 23) with an upper cover (8), as well as providing a sorting cover (33) whose upper forward and lower rear end portions are open at a position opposed to the nozzle cover (32) with these transport belts (23, 23) provided therebetween, a continuous air path from the nozzle cover (32) to the sorting cover(33) is formed.

### BACKGROUND OF THE INVENTION

1. Field of the Invention

The present invention relates to a sorting device for sorting articles being transported into normal articles and defective articles on a carrying path and a quality inspection apparatus using the same and belongs to the field of article selecting techniques.

2. Description of the Related Art

In packaging such food as fried crackers (snack stuff), as disclosed, for example, in Japanese Patent Laid-Open No. 5-180725, quality inspection is ordinarily conducted including weight check of a packaged article and check of contamination of metals after packaging to sort the packaged articles into, for example, normal articles and defective articles based on the inspection results. In this case, with an inspection device for checking weight of a packaged article and the like and a sorting device disposed on such a carrying path for carrying an article packaged by a packaging machine to a shipping work unit or the like as a conveyer, the sorting device, for example, discharges a defective article outside the carrying path and passes a normal article through the path during transport of the articles based on a result of the inspection of weight etc. conducted by the inspection device, thereby sorting the articles.

Among the sorting devices of this kind is a system of blowing air to a packaged article which is detected being defective and transported by a conveyor at a high speed in order to discharge the article outside a carrying path, thereby enhancing a processing speed. In this case, the sorting device includes, for example, a compressor for supplying air as compressed air, a nozzle disposed beside a carrying path of a conveyor and an electromagnetic valve provided in the vicinity of the compressor and is structured such that the compressed air supplied by the nozzle by the opening operation of the electromagnetic valve is blown from the nozzle from the side position of the carrying path toward an article on the carrying path.

With this arrangement, when a packaged article detected being defective by the above-described inspection device for inspecting weight etc. is transported by the conveyor to the position where the nozzle of the sorting device is provided, opening the electromagnetic valve supplies the compressed air to the nozzle and blows the air from the nozzle to the article, thereby discharging the article outside the carrying path and when an article detected being normal is carried, it is transported by the conveyor. According to such a sorting device as described above, as shown in FIG. 6, in a case, for example, of sorting an article X in a light-weight small bag in which rice cookies, biscuits, candies, etc. are packaged and which is transported by a conveyor A, air blown from a nozzle B to the article X ordinarily discharges the article X from the conveyor A toward the direction indicated by an arrow y to sort the article. The air blown from the nozzle B toward the article X, however, ordinarily has no directivity, so that the article X might not be reliably sorted, for example, when directing blown air so as to make the article X have dynamic lift results in the article X floating in the direction indicated by an arrow z and then falling down onto the conveyor A or when directing the blown air to the end portion along the transportation direction of the article X results in the article rotating. This problems occurs in such an article X as described above in a light-weight bag whose one side surface to which air is blown is in many cases not flat.

### SUMMARY OF THE INVENTION

It is accordingly an object of the present invention to provide a sorting device having a cover for regulating a flow of air to be blown from a nozzle to an article which enables an article on a carrying path to be reliably sorted by appropriately blowing air, and a quality inspection apparatus using the same.

According to one aspect of the present invention, a sorting device for discharging a predetermined article to the sideway of the carrying path by blowing air to an article being transported by means of a conveyer includes a nozzle provided on the sideway of the carrying path of the article for blowing air to the article and a nozzle cover for covering the nozzle whose forward-oriented and rearward-oriented end portions in the direction of the air blowing by the nozzle are open and whose forward opening is located forward of a tip of the nozzle.

According to the present invention, with the nozzle cover for covering the nozzle whose forward-oriented and rearward-oriented end portions in the direction of air blowing by the nozzle are open, when air is blown from the nozzle, the air is drawn into the nozzle cover through the rear opening of the nozzle cover, guided by the nozzle cover and blown out through the forward opening together with air blown from the nozzle. Thus, since to the air blown from the nozzle, a air drawn through the rear opening of the nozzle cover and blown from the forward opening is added, even when the amount of air blown from the nozzle is small, the amount of air enough for sorting articles can be ensured.

In addition, with the forward opening of the nozzle cover arranged at a position ahead of a tip of the nozzle, the direction of a flow of air blown from the nozzle and air drawn through the rear opening of the nozzle cover and blown from the forward opening is regulated by the forward opening of the nozzle cover. As a result, an airflow having directivity in relation to an article can be obtained, whereby spaying the air to a predetermined article enables reliable sorting of the article.

Next, a sorting device according to another aspect of the present invention includes an upper cover provided at a position where at least the nozzle cover is disposed and above the carrying path so as to be continuous with an upper surface of the nozzle cover.

According to the present invention, since a flow of air blown with directivity from the forward opening of the nozzle cover is ensured also above the carrying path, reliable sorting of articles can be realized.

A sorting device according to a further aspect of the present invention includes a sorting cover for covering surroundings of a sorted article which is arranged at a position opposed to the nozzle cover with the carrying path provided therebetween.

According to the present invention, sorted articles are guided by the sorting cover, so that they are reliably put into a reclaiming box, for example. Then, the airflow which is blown with directivity from the forward opening of the nozzle cover is ensured up to the position of the sorting cover to enable more reliable sorting of articles.

According to a still further aspect of the present invention, in a sorting device, an air supply opening of the nozzle is formed to be flat whose length in the direction parallel to the carrying path is long.

According to the present invention, supplying air blown from the nozzle to the carrying path in a wide range realizes reliable sorting of articles even when, for example, timing between a time of air blowing from the nozzle and a position of an article more or less deviates from appropriate conditions. Furthermore, because the air supply opening of the nozzle is formed to be flat, at the time of air blowing from the nozzle, air is effectively drawn through the rear opening of the nozzle cover.

Then, according to a still further aspect of the present invention, a quality inspection apparatus using a sorting device for discharging a predetermined article to the sideway of a carrying path by the blowing of air to the article being transported by a transport means includes a nozzle provided on the side of the carrying path of the article for blowing air to the article and a nozzle cover for covering the nozzle whose forward-oriented and rearward-oriented end portions in the direction of the air blowing by the nozzle are open and whose forward opening is located forward of a tip of the nozzle.

According to the present invention, because of provision of the sorting device according to the above embodiment in a quality inspection apparatus such as a weight checker for checking weight of an article, a seal checker for checking sealability of an article packaged with films, a metal detector for detecting metals in an article, an X-ray detector for detecting metals and foreign matters other than metals using soft X-ray and a shape inspection device for inspecting such abnormal shape as cracks and breakage of articles, an article detected being defective by these inspection apparatuses can be reliably sorted. As a result, reliability of inspection processing is improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic side view of a weight checker using a sorting device according to one embodiment of the present invention.

FIG. 2 is a schematic plan view of the weight checker.

FIG. 3 is an expanded side view of a partially cutaway main part of the sorting device.

FIG. 4 is an expanded front view of a partially cutaway main part of the sorting device.

FIG. 5 is an expanded plan view of a partially cutaway main part of the sorting device.

FIG. 6 is a diagram for use in explaining a problem caused in conventional sorting of articles using air blowing.

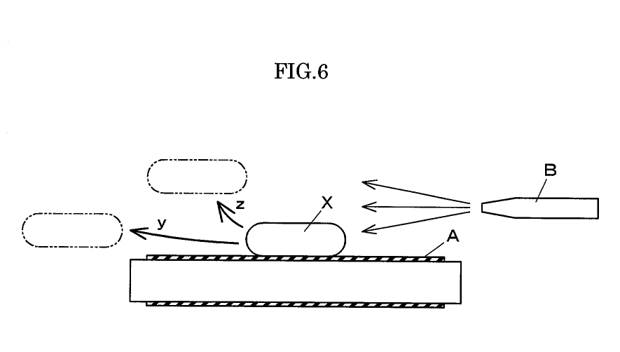

### DESCRIPTION OF THE PREFERRED EMBODIMENT

In the following, a weight checker as a quality inspection apparatus using a sorting device according to one embodiment of the present invention will be described with reference to the drawings.

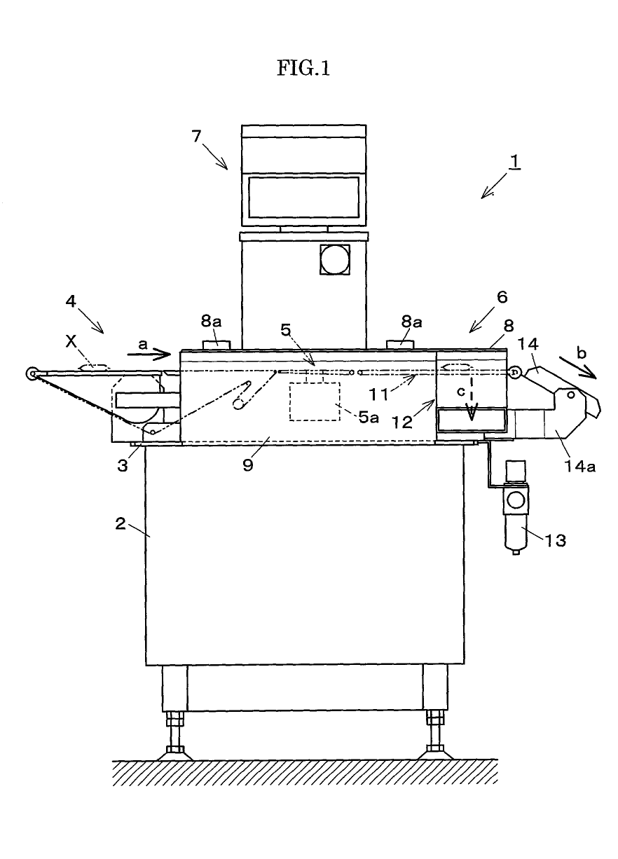

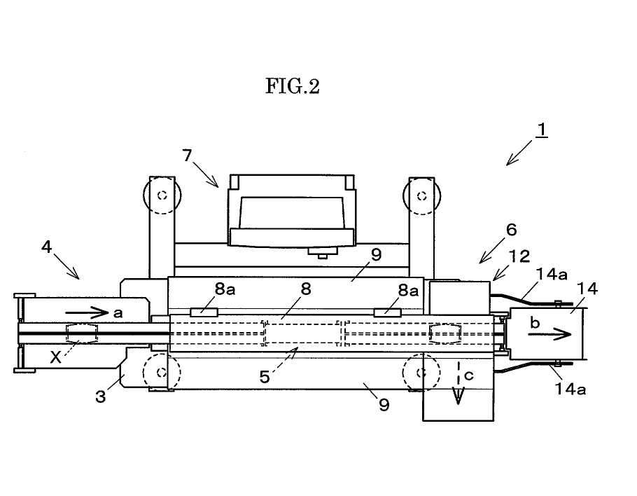

As shown in FIGS. 1 and 2, a weight checker 1 includes, on a supporting member 3 on the upper surface of a main frame 2, an intake conveyor 4, a weighing conveyor 5 and a sorting device 6 from upstream to downstream and further includes an operation panel 7 provided at the back of the weighing conveyor 5 seen from the side, in which, for example, an already packaged article X which is supplied from a packaging machine (not shown) on the upstream side of the weight checker 1 is transported by the intake conveyor 4 to the weighing conveyor 5 on the downstream side as indicated by an arrow “a”, weight of the article X transported on the weighing conveyor 5 is measured by a weight detector 5a including a load cell which is provided in the weighting conveyor 5 and the article X is sorted into a normal article, a defective article or the like by the sorting device 6 on the further downstream side according to the weighing results.

In addition, above a carrying path from the downstream part of the intake conveyor 4 through the weighing conveyor 5 to the sorting device 6, an upper cover 8 is provided to open and close by means of hinges 8a, 8a and on the opposite sides of the carrying path from the downstream part of the intake conveyor 4 through the weighing conveyor 5 to the upstream part of the sorting device 6, a pair of side covers 9, 9 is provided. This arrangement enables the article X on the carrying path to be transported in a good condition and appropriately weighed because effects exerted by a disturbance such as wind around the weighing checker 1 is mitigated.

In the sorting device 6 which is a characteristic part of the present invention, provided above the supporting member 3 are a transport mechanism 11 for transporting the article X received from the weighing conveyor 5 to the downstream side and an air-blow-type sorting mechanism 12 for passing a normal article through the path to discharge the same to the direction indicated by an arrow b and sorting a defective article to the direction indicated by an arrow c, for example.

In addition, provided below the sorting device 6 is a regulator 13 for supplying compressed air from a compressor not shown or the like at a predetermined pressure.

Furthermore, supported by brackets 14a, 14a attached to the sorting device 6 downstream the sorting device 6 is a discharging chute 14 for discharging the article X which passes through the sorting device 6 toward the direction of the arrow b.

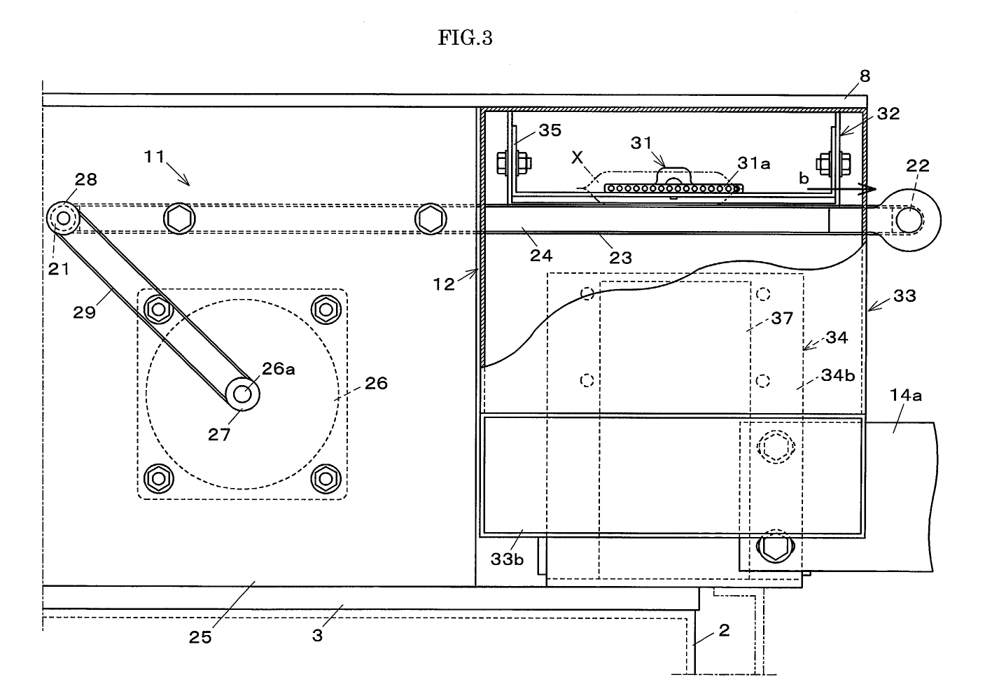

Next, with reference to FIGS. 3, 4 and 5, the sorting device 6 will be described in detail.

First, in the transport mechanism 11, a driving roller 21 is disposed on the upstream side and a driven roller 22 is disposed on the downstream side, between which rollers 21 and 22 a pair of transport belts 23, 23 for transporting the article X is wound in parallel to each other. The transport belts 23, 23 are supported by a top board 24 so as not to be loose.

Then, on the upper surface of the supporting member 3, a fixing frame 25 is provided to stand on one side along the transportation direction and on the upper portion of the fixing frame 25, the driving roller 21 and the top board 24 are mounted.

Furthermore, as shown in FIG. 3, provided in the lower portion of the fixing frame 25 is a motor 26, and between a pulley 27 attached in coaxial with an output shaft 26a of the motor 26 and a pulley 28 attached in coaxial with the driving roller 21, a timing belt 29 is wound, so that driving of the motor 26 causes the transport belts 23 to run, thereby transporting the article X put on the transport belts 23, 23 from the upstream side toward the downstream side.

The sorting mechanism 12 is provided with a nozzle cover 32 disposed at the right side seen from the front for covering a nozzle 31 which blows air to a predetermined article X and a sorting cover 33 for guiding the article X sorted using air toward the direction of the arrow c which is disposed at a position opposed to the nozzle cover 32 with the transport belts 23, 23 which are covered with the upper cover 8 provided therebetween, whereby a continuous air path is formed from the nozzle cover 32 to the sorting cover 33 through the upper cover 8.

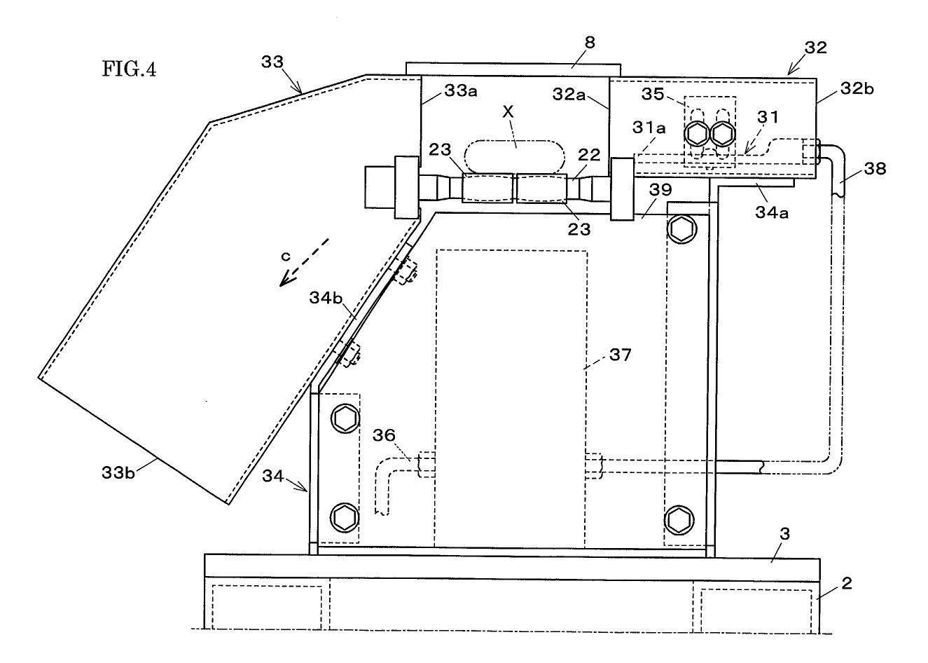

The nozzle cover 32 is fixed to a curved portion 34a at the upper right portion of an attachment frame 34 standing on the supporting member 3 seen from the front (see FIG. 4) and has its end portions open 32a, 32b which are forward-oriented and rearward-oriented relative to the article X transported by the transport mechanism 11, and the forward opening 32a of the nozzle cover 32 is located forward of a tip portion 31a of the nozzle 31 fixed in the nozzle cover 32 so as to have its fixed position adjustable using a bracket 35. Then, the nozzle cover 32 is arranged to have its forward opening 32a disposed slightly inward from one edge portion of the upper cover 8.

The tip portion 31a of the nozzle 31 is formed to be flat whose length in the direction parallel to the transport surface of the transport belts 23, 23 is long and is composed of numerous compressed air supply openings aligned in the transportation direction. Although the direction of airblow by the nozzle 31 is fixed by the nozzle cover 32 using the bracket 35 so as to be approximately horizontal to the transport surface of the transport belt 23, 23 in this embodiment, the airblow direction may be fixed to be slant in relation to the transport surface according to the shape of the article X to be transported or the packaged contents.

On the other hand, the sorting cover 33 disposed at a position opposed to the nozzle cover 32 with the transport belts 23, 23 provided therebetween is fixed to a slant portion 34b at the upper left portion of the attachment frame 34 seen from the front (see FIG. 4) and has its end portions open 33a, 33b which are upper-forward-oriented and lower-rearward-oriented relative to the article X transported by the transport mechanism 11. Then, the sorting cover 33 is fixed to the attachment frame 34 such that the upper forward opening 33a is disposed slightly inward from the other edge portion of the upper cover 8. The opening 33b at the lower rear part of the sorting cover 33 is arranged to guide the sorted article X to a reclaiming box (not shown) which is disposed below or the like.

In addition, disposed inside the attachment frame 34 is an electromagnetic valve 37 connected to the regulator 13 (see FIG. 1) through a piping 36 and to the electromagnetic valve 37, the nozzle 31 is connected through a piping 38. In this case, since the electromagnetic valve 37 is arranged at a part close to the nozzle 31, responsiveness of opening and closing operation is excellent, while the amount of air pressure lost before reaching the nozzle 31 can be reduced.

Then, at this side and at the back of the attachment frame 34 seen from the front, side plates 39, 39 are mounted (only the plate this side is illustrated in FIG. 4) to protect the electromagnetic valve 37 disposed inside the attachment frame 34.

Next, operation of the weight checker 1 according to the present embodiment will be described.

First, for example, when the packaged article X supplied from the packaging machine on the upstream side to the intake conveyor 4 is transported to the direction indicated by the arrow a and further received by the weighing conveyor 5, weight inspection is conducted by the weight detector 5a.

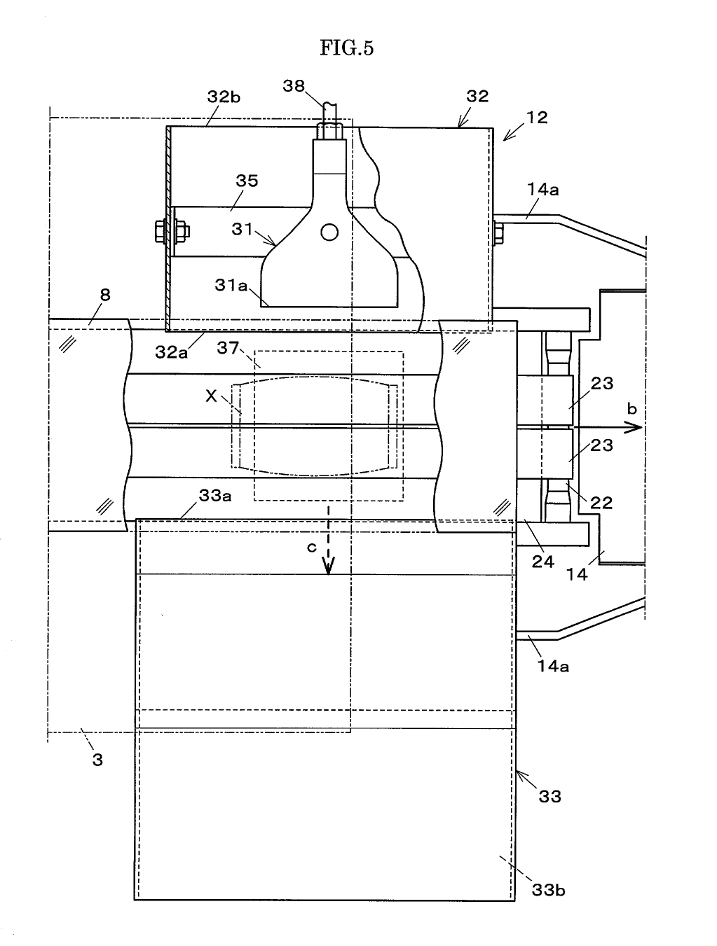

After the weight inspection, the article X is delivered from the weighting conveyor 5 to the sorting device 6. In this sorting device 6, when the article X is a normal article whose weight is within a predetermined allowable range with respect to a predetermined target weight, a control unit not shown, for example, outputs no control signal for opening the electromagnetic valve 37, whereby no air is blown to the article X from the nozzle 31. As a result, the article X as a normal article is put on the transport belts 23, 23 of the transport mechanism 11 and transported and then discharged by the discharging chute 14 to the direction indicated by the arrow b (see FIG. 5).

On the other hand, when the article X is a defective article whose weight is out of the predetermined allowable range with respect to the predetermined target weight, that is, a defective article which is overweight or underweight, the control unit outputs a control signal for opening the electromagnetic valve 37, so that air is blown to the article X from the nozzle 31. As a result, the article X as a defective article will be discharged toward the sorting cover 33 provided on one side of the transport belts 23, 23 as indicated by the arrow c (see FIG. 5).

In this case, because the nozzle 31 is covered with the nozzle cover 32 and the forward-oriented and rearward-oriented end portions 32a and 32b of the nozzle cover 32 are formed to be open, air blown from the nozzle 31 causes air to be drawn into the nozzle cover 32 through the rear opening 32b of the nozzle cover 32, guided by the nozzle cover 32 and blown out through the forward opening 32a together with the air blown from the nozzle 31. Accordingly, since the air drawn from the rear opening 32b of the nozzle cover 32 and blown from the forward opening 32a is added to the air blown from the nozzle 31, the amount of the air sufficient for sorting articles can be ensured even if the amount of the air blown from the nozzle 31 is small. As a result, a pressure of compressed air supplied to the nozzle 31 can be reduced to enable a compressed air supply system to be made small in size, for example.

Moreover, with the forward opening 32a of the nozzle cover 32 being positioned forward of the tip portion 31a of the nozzle 31 and the forward opening 32a of the nozzle cover 32 being disposed at a position slightly inward from one edge portion of the upper cover 8 covering the transport belts 23, 23, because of arrangement of the upper forward opening 33a of the sorting cover 33 provided at a position opposed to the nozzle cover 32 with the transport belts 23, 23 provided therebetween such that it is located at a position slightly inward from the other edge portion of the upper cover 8, the flow of air blown from the nozzle 31 and air drawn through the rear opening 32b of the nozzle cover 32 and blown from the forward opening 32a is regulated, while a flow of air having directivity can be ensured continuously from the nozzle cover 32 to the sorting cover 33. As a result, an airflow having the directivity with respect to the article X can be obtained, so that blowing air to a predetermined article X enables reliable sorting of the article X, thereby enabling the article X to be guided into a reclaiming box, for example, through the lower rear opening 33b of the sorting cover 33.

Then, with the tip portion 31a of the nozzle 31 formed to be flat whose length in parallel to the transport surface of the transport belts 23, 23 is long, air is blown in a wide range, whereby the article X can be reliably sorted even when timing between a time of airblow from the nozzle 31 and a position of the article X deviates more or less from appropriate conditions.

Although the embodiment has been described in detail with respect to a case where the weight checker 1 is used as a quality inspection apparatus, also when such quality inspection apparatuses as a seal checker, a metal detector, an X-ray inspection device and a shape inspection device are used, articles inspected at these inspection apparatuses can be reliably sorted according to inspection results in the same manner as that described above.

As described in the foregoing, according to the present invention, a predetermined article X can be reliably sorted by the sorting device and by the quality inspection apparatus using the same. Moreover, a compressed air supply system, for example, can be made small in size. The present invention is widely applicable to various kinds of quality inspection apparatuses such as a weight checker, a seal checker, a metal detector, an X-ray detector and a shape inspection device to further improve reliability of these inspection apparatuses.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A sorting device for discharging a predetermined article to the sideway of a carrying path by blowing air to an article being transported by a conveyer, comprising a nozzle provided on the side of the carrying path of said article for blowing air to said article and a nozzle cover for covering the nozzle whose forward-oriented and rearward-oriented end portions in the air blowing direction are open and whose forward opening is located forward of a tip of the nozzle.

2. The sorting device according to claim 1, wherein an upper cover is provided at a position where at least the nozzle cover is disposed and above the carrying path so as to be continuous with an upper surface of said nozzle cover.

3. The sorting device according to claim 1, wherein a sorting cover for covering surroundings of a sorted article is provided at a position opposed to the nozzle cover with the carrying path provided therebetween.

4. The sorting device according to claim 2, wherein a sorting cover for covering surroundings of a sorted article is provided at a position opposed to the nozzle cover with the carrying path provided therebetween.

5. The sorting device according to claim 1, wherein an air supply opening of the nozzle is formed to be flat whose length in the direction parallel to the carrying path is long.

6. The sorting device according to claim 2, wherein an air supply opening of the nozzle is formed to be flat whose length in the direction parallel to the carrying path is long.

7. The sorting device according to claim 3, wherein an air supply opening of the nozzle is formed to be flat whose length in the direction parallel to the carrying path is long.

8. A quality inspection apparatus using a sorting device for discharging a predetermined article to the sideway of a carrying path by blowing air to the article being transported by a conveyer, comprising a nozzle provided on the side of the carrying path of said article for blowing air to said article and a nozzle cover for covering the nozzle whose forward-oriented and rearward-oriented end portions in the air blowing direction are open and whose forward opening is located forward of a tip of the nozzle.
